(19) United States
(12) Patent Application Publication
(10) Pub. No.: US 2007/0000659 A1
(43) Pub. Date: Jan. 4, 2007

(54) Vehicle environmental control system and related method

(76) Inventors: Steven E. Schlanger, Flagstaff, AZ (US); W. Frank Ableson, Stanhope, NJ (US)

Correspondence Address: STEPHEN T. SULLIVAN, UNWIRED TOOLS, LLC, 7001 EAST PARADISE DRIVE, SCOTTSDALE, AZ, 85254-5175, US

(21) Appl. No.: 11/174,300

(22) Filed: Jun. 29, 2005

(51) Int. Cl. B60H 1/00

(52) U.S. Cl. 165/202; 165/204

(57) ABSTRACT

A system is provided for controlling air temperature in an ambient space in a vehicle using an environmental control system that includes a temperature adjusted air source system and an ambient sensor system in thermal communication with the ambient space. The system includes a working fluid flow control valve operatively coupled to a working fluid flow control value actuator, wherein the working fluid flow control valve is operative to control the flow of a working fluid in the temperature adjusted air source system, an air flow valve operatively coupled to an air flow valve actuator operative to control air flow from the temperature adjusted air source system that is entering the ambient space, a control signal source that provides a control signal, and a digital microcontroller operatively coupled to the ambient sensor system, to the working fluid flow control valve actuator, and to the air flow valve actuator, which digital microcontroller issues commands to the working fluid flow control valve actuator and the air flow valve actuator in response to the control signal to control the flow of the working fluid in the temperature adjusted air source system and to control the flow of air into the ambient space using the air flow control system. Related systems and methods also are disclosed.

### BACKGROUND OF THE INVENTION

1. Field of the Invention

The present invention relates to vehicle environmental control systems, such as vehicle heater and air conditioning systems, and the like, and, more specifically, to servo control systems for controlling such environmental control systems.

2. Description of the Related Art

The task of a vehicle environmental control system of course is to maintain the comfort of the passenger compartment so that the ambient air temperature is comfortable for the vehicle occupants regardless of external conditions. To achieve this end, many environment control systems include features such as manual and automatic air flow or flow rate controls, selective use of certain vents to distribute air to specific portions of the passenger compartment, and the like.

An illustrative environmental control system 10 according to known designs is shown in FIG. 1. This figure depicts a system that has been incorporated into Mercedes Benz vehicles known as the ACC II Control System. System 10 includes a heater system 12, an air flow control system 14, and a sensor system 16. Heater system 12 includes a hot water loop 18 that circulates water through the engine (not shown) to warm it and a heat exchanger (not shown) that blows air over the hot water loop to warm the air. Air flow control system 14 directs that warmed air through the venting system and delivers it to the passenger compartment. In this illustrative system, air flow control system 14 operates in conjunction with a vacuum source or system 20. In some systems, the air flow system selectively directs the warmed air to different sets of vents to improve comfort. When the difference between the set point and the interior temperature in the passenger compartment is pronounced, e.g., more than 5° F., air flow system 14 may direct the warmed air to the floor vents and close the dash panel vents.

Sensor system 16 typically includes a user-controlled temperature dial 22 for setting a desired passenger compartment temperature, an inside temperature sensor 24 for monitoring the temperature inside the passenger compartment, and an outside temperature sensor for monitoring the temperature outside the passenger compartment (external to the vehicle). These sensors typically are configured in series to form a sensor chain.

System 10 also includes a servo 30 which in turn comprises a motor 32, a potentiometer 34, and a servo amplifier 36. Motor 32 is mechanically coupled via a shaft 38 to a hot water valve 40 that controls hot water loop 18, and via the same shaft 38 to a series of vacuum valves 42 for controlling air flow in the air flow system 14. The latter typically involves selectively opening and closing certain air vent flaps to direct air into the passenger compartment in a way that optimizes passenger comfort under the prevailing conditions. Motor 32 is controlled by sensor chain 16 in the following manner. Potentiometer 34 is coupled to the output of sensor chain 16, and to servo amplifier 36. Servo amplifier 36, which comprises an operational amplifier, is coupled to motor 32. When the signal from sensor chain 16 exceeds a set point, servo amplifier causes motor 32 to actuate and move to the appropriate position. This causes hot water valve 40 to be set to the desired position. It also causes vacuum valves 42 to set the air flow control system 14 appropriately for the circumstances.

Although only the heating system is illustrated and described, an air conditioning (cooling) function also is provided by this system. For example, when cooling, and thus the signal from sensor chain 16 is less than a set point, servo amplifier 36 causes motor 32 to actuate and move to reduce the flow of hot water through valve 40 to be set to the desired position. It also causes vacuum valves 42 to set the air flow control system 14 appropriately for the cooling.

Such servo designs have been subject to a number of persistent problems. A major source of such problems is attributable to the use of a mechanical, motorized servo design approach, for example, using motor 32. With such designs, the valves adjusting flow of the working fluid of the heating and air conditioning system, such as hot water valves, are subject to dirt, contamination, alignment, and mechanical or physical wear. The motors also are subject to loss of power or torque and precision, for example, as brushes wear. Other precision losses also are common. The potentiometers, for example, commonly go out of calibration as they wear and as conditions change.

### OBJECTS OF THE INVENTION

Accordingly, an object of the present invention is to provide servo systems and methods for a vehicle environmental control system that are reliable.

Another object of the present invention is to provide servo systems and methods for a vehicle environmental control system that are durable.

Still another object of the present invention is to provide servo systems and methods for a vehicle environmental control system that are accurate.

Additional objects and advantages of the invention will be set forth in the description which follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, a system is provided for controlling air temperature in an ambient space in a vehicle using an environmental control system. The environmental control system comprises a temperature adjusted air source system and an ambient sensor system in thermal communication with the ambient space, such as the passenger compartment of the vehicle. The system according to this aspect of the invention comprises a working fluid flow control valve operatively coupled to a working fluid flow control value actuator. The working fluid flow control valve is operative to control the flow of a working fluid in the temperature adjusted air source system.

The system further comprises a control signal source that provides a control signal. The system still further comprises a digital microcontroller operatively coupled to the ambient sensor system and to the working fluid flow control valve actuator. The digital microcontroller issues commands to the working fluid flow control valve actuator in response to the control signal to control the flow of the working fluid in the temperature adjusted air source system.

In accordance with another aspect of the invention, a system is provided for controlling air temperature in an ambient space in a vehicle using an environmental control system that comprises a temperature adjusted air source system, an air flow control system and an ambient sensor system in thermal communication with the ambient space.

The system according to this aspect of the invention comprises an air flow valve operatively coupled to an air flow valve actuator operative to control air flow from the temperature adjusted air source system that is entering the ambient space, a control signal source that provides a control signal, and a digital microcontroller operatively coupled to the ambient sensor system and to the air flow valve actuator, which digital microcontroller issues commands to the working fluid flow control valve actuator and the air flow valve actuator in response to the control signal to control the flow of air into the ambient space using the air flow control system.

In accordance with another aspect of the invention, a system is provided for controlling air temperature in an ambient space in a vehicle using an environmental control system that comprises a temperature adjusted air source system, an air flow control system and an ambient sensor system in thermal communication with the ambient space, wherein the system according to this aspect of the invention comprises a working fluid flow control valve operatively coupled to a working fluid flow control value actuator, the working fluid flow control valve being operative to control the flow of a working fluid in the temperature adjusted air source system, an air flow valve operatively coupled to an air flow valve actuator operative to control air flow from the temperature adjusted air source system that is entering the ambient space, a control signal source that provides a control signal, and a digital microcontroller operatively coupled to the ambient sensor system, to the working fluid flow control valve actuator, and to the air flow valve actuator. The digital microcontroller issues commands to the working fluid flow control valve actuator and the air flow valve actuator in response to the control signal to control the flow of the working fluid in the temperature adjusted air source system and to control the flow of air into the ambient space using the air flow control system.

In preferred embodiments according to each of these aspects of the invention, the microcontroller optionally but preferably comprises software. Optionally but, again, preferably, the microcontroller is programmable. Preferably the microcontroller is programmable while the microcontroller is physically disposed in the system. The microcontroller preferably comprises means for receiving a programming signal. In one aspect, this means may comprise means for receiving a programming signal electrically e.g., such as via an electrical conductor. In the presently preferred embodiment, the microcontroller is wirelessly programmable. Accordingly, in its various embodiments, the microcontroller comprises means for receiving an electromagnetic programming signal, such as an electromagnetic receiver that receives an electromagnetic programming signal. The wireless programming also may be accomplished optically, wherein the microcontroller may comprise means for receiving an optical programming signal, e.g., such as wherein the microcontroller comprises an optical receiver that receives an optical programming signal. The wireless programming also may be carried out using an infrared signal, so that, e.g., the microcontroller may comprise means for receiving an infrared programming signal, e.g., such as wherein the microcontroller comprises an infrared receiver that receives an infrared programming signal.

In embodiments that comprise a working fluid flow control valve actuator, that actuator preferably is located at the working fluid flow control value. Preferably an electrical conductor operatively couples the microcontroller to the working fluid flow control value actuator.

Similarly, in preferred system embodiments that include an air flow valve actuator, that actuator preferably is positioned at the air flow control valve. In presently preferred embodiments, the system may further comprises means for operatively coupling the microcontroller to the air flow control value actuator electrically, e.g., using an electrical conductor to operatively couple the microcontroller to the air flow control value actuator.

In accordance with another aspect of the invention, a method is provided for controlling air temperature in an ambient space in a vehicle using an environmental control system that comprises a temperature adjusted air source system and an ambient sensor system in thermal communication with the ambient space. The method according to this aspect of the invention comprises providing a digital microcontroller, operatively coupling the digital microcontroller to the ambient sensor system, operatively coupling a working fluid flow control valve actuator to a working fluid flow control value, wherein the working fluid flow control valve is operative to control the flow of a working fluid in the temperature adjusted air source system, and operatively coupling the working fluid flow control valve actuator to the microcontroller. The method further comprises using a control signal source to provide a control signal, and using the microcontroller to issue commands to the working fluid flow control valve actuator in response to the control signal to control the flow of the working fluid in the temperature adjusted air source system.

In accordance with another aspect of the invention, a method is provided for controlling air temperature in an ambient space in a vehicle using an environmental control system that comprises a temperature adjusted air source system, an air flow control system and an ambient sensor system in thermal communication with the ambient space. The method comprises providing a digital microcontroller, operatively coupling the digital microcontroller to the ambient sensor system, operatively coupling an air flow valve actuator to an air flow valve operative to control air flow from the temperature adjusted air source system that enters the ambient space, and operatively coupling the air flow valve actuator to the microcontroller, using a control signal source to provide a control signal, and using the microcontroller to issue commands to the air flow valve actuator in response to the control signal to control the flow of air into the ambient space using the air flow control system.

In accordance with yet another embodiment of the invention, a method is provided for controlling air temperature in an ambient space in a vehicle using an environmental control system that comprises a temperature adjusted air source system, an air flow control system and an ambient sensor system in thermal communication with the ambient space. The method comprises providing a digital microcontroller, operatively coupling the digital microcontroller to the ambient sensor system, operatively coupling a working fluid flow control valve actuator to a working fluid flow control value, wherein the working fluid flow control valve is operative to control the flow of a working fluid in the temperature adjusted air source system, and operatively coupling the working fluid flow control valve actuator to the microcontroller, operatively coupling an air flow valve actuator to an air flow valve operative to control air flow from the temperature adjusted air source system that enters the ambient space, and operatively coupling the air flow valve actuator to the microcontroller, using a control signal source to provide a control signal, and using the microcontroller to issue commands to the working fluid flow control valve actuator and the air flow valve actuator in response to the control signal to control the flow of the working fluid in the temperature adjusted air source system and to control the flow of air into the ambient space using the air flow control system, respectively.

In preferred implementations of each of these method aspects of the invention, the issuance of the commands preferably comprises using software in the microcontroller to process the control signal. In each of them, optionally but preferably the method comprises programming the microcontroller, preferably but optionally while the microcontroller is operatively coupled to the working fluid flow control valve actuator and/or to the air flow control valve actuator.

It is optional but preferred in these methods that the programming of the microcontroller comprises programming the microcontroller wirelessly. This may comprise programming the microcontroller wirelessly using an electromagnetic programming signal, an optical programming signal, an infrared signal, or some combination of these.

In method implementations that involve a working fluid flow control valve and actuator, the coupling of the working fluid flow control valve actuator to the working fluid flow control value preferably comprises positioning the working fluid flow control valve actuator at the working fluid flow control valve. The coupling of the working fluid flow control valve actuator to the microcontroller also preferably comprises coupling the microcontroller to the working fluid flow control value actuator electrically.

In method implementations that comprise an air control valve and actuator, the coupling of the air flow valve to the air flow valve actuator optionally but preferably comprises positioning the air flow control valve actuator at the air flow control valve. The coupling of the air flow valve to the air flow valve actuator preferably comprises positioning the air flow.

### BRIEF DESCRIPTION OF THE DRAWINGS

The accompanying drawings, which are incorporated in and constitute a part of the specification, illustrate a presently preferred embodiments and methods of the invention and, together with the general description given above and the detailed description of the preferred embodiments and methods given below, serve to explain the principles of the invention. Of the drawings:

FIG. 1 is an illustrative servo control system for a vehicle environmental control system according to a known and commercially available system;

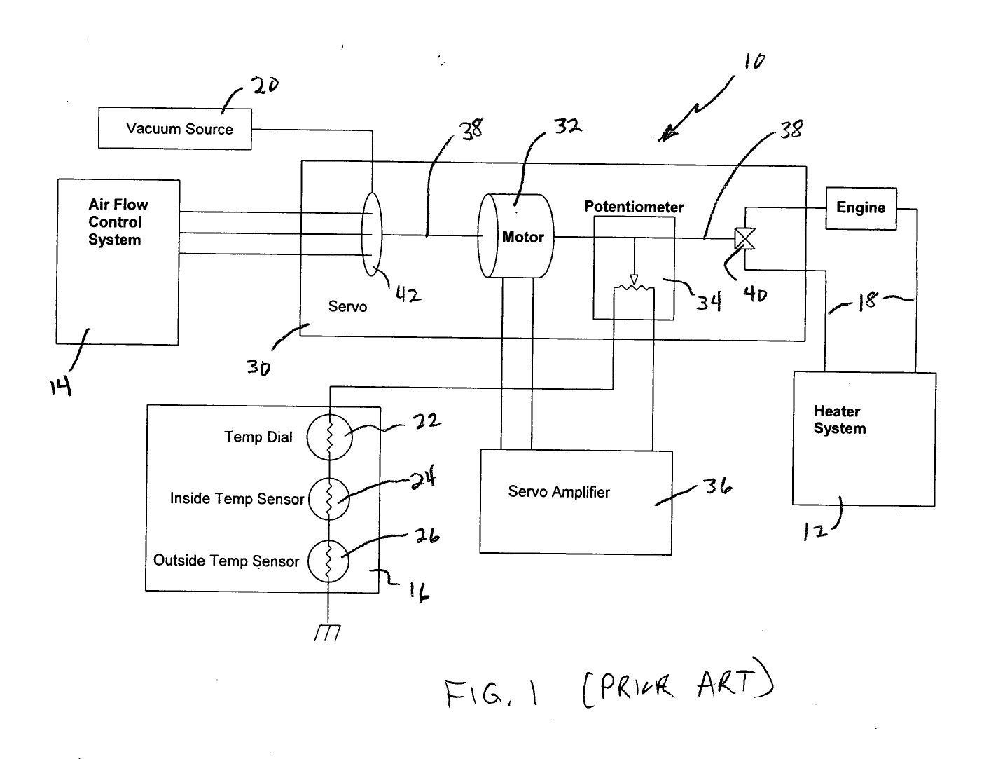

FIG. 2 illustrates a presently preferred embodiment and presently preferred method implementation according to aspects of the invention, as they are incorporated into a vehicle environmental control system;

FIG. 3 shows a second preferred embodiment and presently preferred method implementation according to aspects of the invention, as they are incorporated into a vehicle environmental control system; and

FIG. 4 shows a flow diagram of processing within the microcontroller of the systems shown in FIGS. 2 and 3.

### DETAILED DESCRIPTION OF THE PREFERRED EMBODIMENTS AND METHODS

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

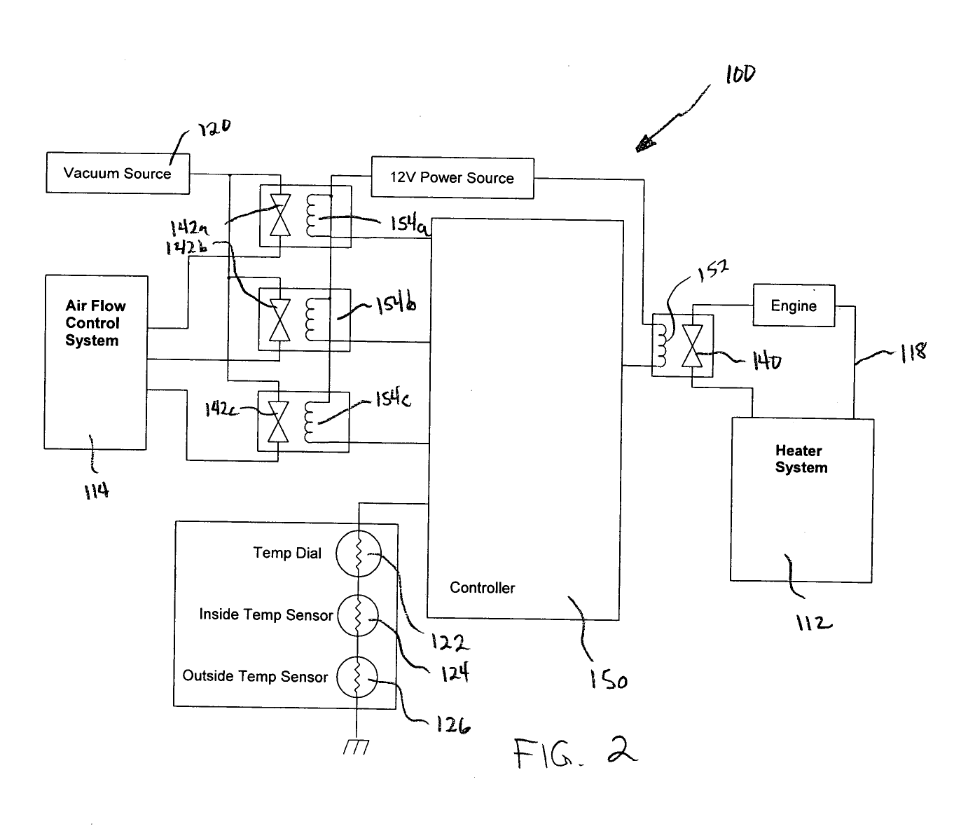

A system 100 according to a presently preferred embodiment of the invention will now be described with reference to FIG. 2. This system 100 is adapted to control air temperature in an ambient space in a vehicle, such as a car, truck or the like. The ambient space (not shown) may be any space for which temperature control is desired. This would include, for example, the passenger compartment of the vehicle. System 100 is illustrated as being incorporated into a vehicle that has an environmental control system that comprises a temperature adjusted air source system (selected components shown, as described herein), an air flow control system, and an ambient sensor system in thermal communication with the ambient space. For each of these vehicle environmental control subsystems, only selected components are shown.

The temperature adjusted air source system may be any system or subsystem that provides air for the ambient space. Examples, include passenger compartment heating and air conditioning systems. Such systems typically utilize a working fluid, examples of which would include hot water for heating systems, and Freon or like fluids for air conditioning systems. The temperature adjusted air source system as illustrated in FIG. 2 comprises a heating and air conditioning system 112 that further comprises a hot water loop 118. Flow of the working fluid in this system is controlled by a valve as described more fully herein below.

Air flow control system or subsystem 114 comprises a series of air flow vents for air flow into and out of the passenger compartment or other ambient space. In this illustrative example it includes dash vents in or around the dash of the car, and floor or leg vents in the lower portion of the compartment. Some or all of these vents may include doors or flaps that can direct, limit or even prevent air flow.

The ambient sensor system 116 may comprise any sensor, collection or system of sensors, or other monitoring device or devices that are capable of providing the temperature sensing functions described herein. This system or subsystem may comprise a collection or chain of sensors, for example, as described herein. In this illustrative embodiment, sensor system 116 comprises a temperature dial 122, an inside temperature sensor 124, and an external temperature sensor 126.

System 100 comprises a digital microcontroller 150 operatively coupled to system components as shown in the drawings and described herein below. Microcontroller 150 in this presently preferred embodiment comprises a Microchip 16F72 microcontroller chip, commercially available from Microchip Technology, Inc. of Phoenix, Ariz., programmed and configured as described herein below. Microprocessor 150 preferably is disposed on a printed circuit board that can be readily installed in the vehicle, preferably in the engine compartment or other suitable location.

Microcontroller 150 is operatively coupled to ambient sensor system 116, and more specifically to the sensor chain that comprises temperature dial 122 and sensors 124 and 126. This preferably comprises a series connection. This sensor chain 116 is connected to microcontroller 150. Incidentally, operative coupling as the term is used herein preferably is used in a broad sense to include not only direct ohmic connection or connection, but also indirect connection, such as reactive coupling, or coupling through another device or alternate path.

Microcontroller 150 also is operatively coupled to temperature adjusted air source system (here heating and air conditioning system 112). More specifically, in this embodiment, the temperature adjusted air source system includes a working fluid flow control valve 140, here a hot water valve 140, that regulates or controls the flow of the working fluid in the temperature adjusted air source system. A working fluid flow control valve actuator 152, which here comprises an electrical solenoid, is coupled to hot water valve 140 to actuate and control valve 140. The working fluid flow control valve actuator 152 in this embodiment, and preferably, is located at the working fluid flow control valve 140. Actuator 152 is operatively coupled to and under the control of microcontroller 150. An electrical conductor preferably is used to operatively coupling the microcontroller to the working fluid flow control value actuator 152.

Microcontroller 150 also is operatively coupled to the air flow control system. More specifically, the air flow control system includes at least one, and typically a series of valves, usually vacuum valves, for controlling the state of air flow into the ambient space of the vehicle. In this illustrative embodiment, these valves comprise vacuum valves 142a, 142b and 142c. Each of these vacuum valves is operatively coupled to a vacuum source 120, and also is operatively coupled to an air vent or component thereof, such as a vent door or flap.

In system 100, each valve 142a-c is operatively coupled to an air flow valve actuator 154a, 154b, and 154c, respectively, adapted to control and regulate its corresponding vacuum valve 142a-c. Each of the air flow valve actuators 154a-c preferably is positioned at a corresponding one or group of the air flow control valves 142a-c. Valve actuators 154a-c, which in this preferred embodiment comprise solenoid valves, are operatively coupled to microcontroller 150, preferably by wires or other electrical conductors.

System 100 further comprises a control signal source that provides a control signal. In this embodiment, the control signal source comprises sensor system 116, and more specifically comprises temperature dial 122, and sensors 124 and 126.

In operation and according to the preferred method implementations of the invention, microcontroller 150 issues commands to the working fluid flow control valve actuator or actuators 152 and to the air flow valve actuator or actuators 154a-c in response to a control signal, for example, from temperature dial 122, to control the flow of the working fluid in the temperature adjusted air source system and to control the flow of air into the ambient space using the air flow control system.

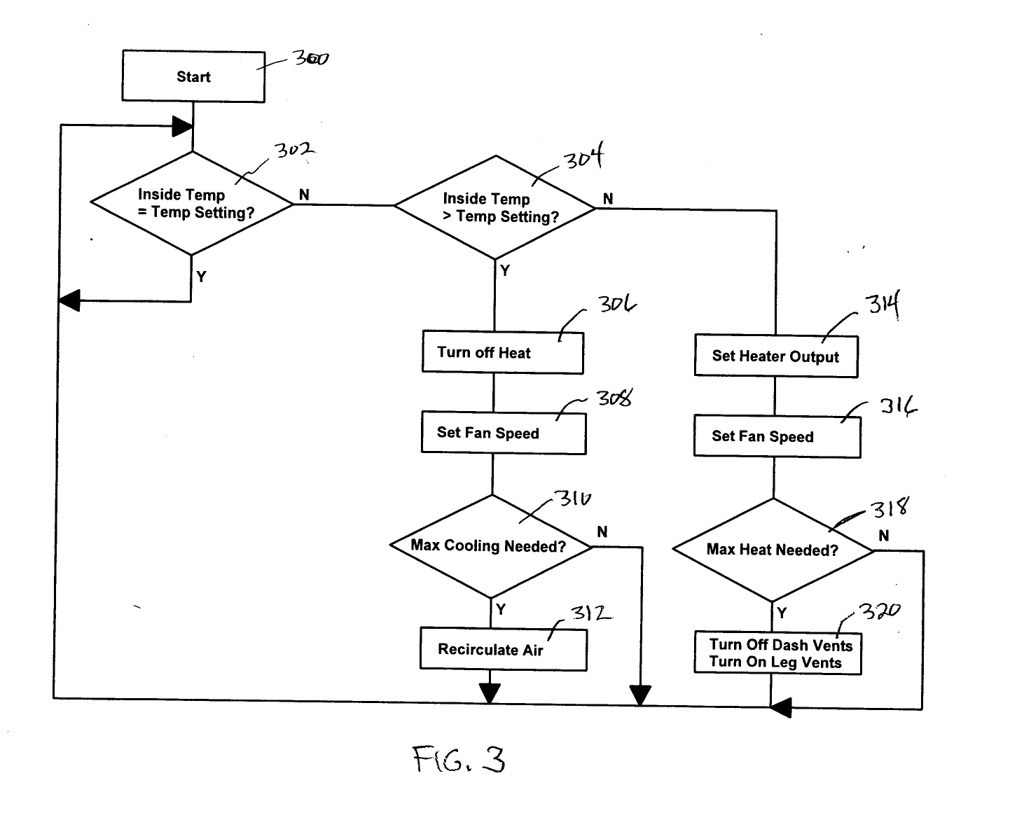

In this preferred system embodiment and in presently preferred implementations of the methods according to the invention, microcontroller 150 comprises software that enables it to perform some or all of the functions described herein. With reference to FIG. 3, the preferred system and method processing starts at the START block 300 in FIG. 3. Initially a determination is made whether the inside temperature within the ambient space is equal to a predetermined or programmed temperature setting (block 302). If yes, a time delay, e.g., of about 0.5 seconds, is interjected, and the temperature comparison is made again (block 302). If no, a determination is made whether the inside temperature is greater than the temperature setting (block 304). If yes, the heating function is turned off (block 306) and the fan speed is set at a desired rate (block 308). It is then determined whether maximum cooling is needed (block 310), for example, where the temperature difference between the inside temperature and the temperature set point is greater than a predetermined threshold amount. If maximum cooling is needed, the vents are set to recirculate the air flow (block 312), and control is returned to the initial block 302). If maximum cooling is not needed, control returns to the initial block 302).

If at block 304 the inside temperature is determined to be less than the temperature setting, the heater output (block 14) and fan speed are set according to predetermined settings. A determination is then made whether maximum heating is required (block 318). If yes, the dash vents are turned off and the leg or floor vents are turned on, and processing continues at initial block 302. If no, processing returns directly to initial block 302.

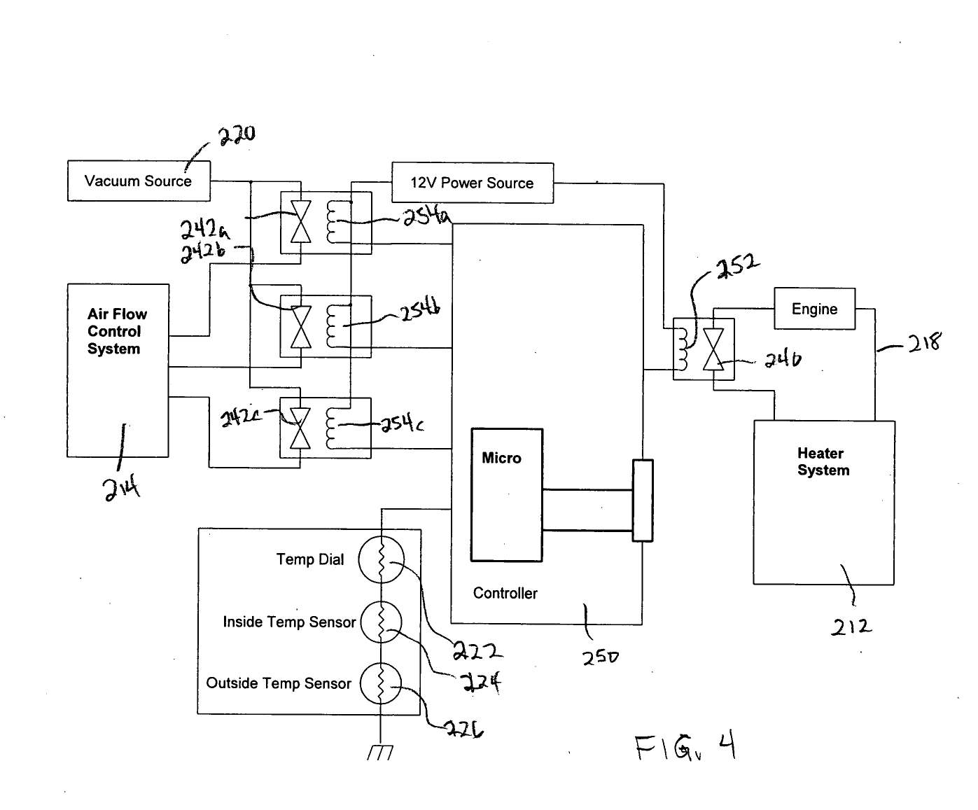

In presently preferred embodiments of the invention and in presently preferred method implementations, microcontroller 150 is programmable. Microcontroller 250 is programmable while the microcontroller is physically disposed in the system. An illustrative embodiment demonstrating this optional but preferred aspect of the invention is illustrated will now be described with reference to FIG. 4. In FIG. 4, a system 200 essentially identical to system 100 is depicted. In system 200, however, a programming and diagnostics interface is provided that enables programming (including re-programming) information (programs and/or data) to be received, and for programming to occur. Microcontroller 250 and/or its associated peripheral hardware therefore comprises means for receiving a programming signal. Such means may comprise means for receiving the programming information electrically (e.g., via bus or cable), or wirelessly, e.g., electromagnetically, optically, via infrared, and the like. Such means may comprise programming devices and methods such as those disclosed in applicant's co-pending U.S. patent application Ser. No. 10/897,325, the entire disclosure of which is incorporated herein by express reference.

Having described the invention and its presently preferred embodiments and method implementations, additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

What is claimed is:

1. A system for controlling air temperature in an ambient space in a vehicle using an environmental control system that comprises a temperature adjusted air source system and an ambient sensor system in thermal communication with the ambient space, the system comprising:
a working fluid flow control valve operatively coupled to a working fluid flow control value actuator, the working fluid flow control valve being operative to control the flow of a working fluid in the temperature adjusted air source system;
a control signal source that provides a control signal; and
a digital microcontroller operatively coupled to the ambient sensor system and to the working fluid flow control valve actuator, which digital microcontroller issues commands to the working fluid flow control valve actuator in response to the control signal to control the flow of the working fluid in the temperature adjusted air source system.

2. A system for controlling air temperature in an ambient space in a vehicle using an environmental control system that comprises a temperature adjusted air source system, an air flow control system and an ambient sensor system in thermal communication with the ambient space, the system comprising:
an air flow valve operatively coupled to an air flow valve actuator operative to control air flow from the temperature adjusted air source system that is entering the ambient space;
a control signal source that provides a control signal; and
a digital microcontroller operatively coupled to the ambient sensor system and to the air flow valve actuator, which digital microcontroller issues commands to the working fluid flow control valve actuator and the air flow valve actuator in response to the control signal to control the flow of air into the ambient space using the air flow control system.

3. A system for controlling air temperature in an ambient space in a vehicle using an environmental control system that comprises a temperature adjusted air source system, an air flow control system and an ambient sensor system in thermal communication with the ambient space, the system comprising:
a working fluid flow control valve operatively coupled to a working fluid flow control value actuator, the working fluid flow control valve being operative to control the flow of a working fluid in the temperature adjusted air source system;
an air flow valve operatively coupled to an air flow valve actuator operative to control air flow from the temperature adjusted air source system that is entering the ambient space;
a control signal source that provides a control signal; and
a digital microcontroller operatively coupled to the ambient sensor system, to the working fluid flow control valve actuator, and to the air flow valve actuator, which digital microcontroller issues commands to the working fluid flow control valve actuator and the air flow valve actuator in response to the control signal to control the flow of the working fluid in the temperature adjusted air source system and to control the flow of air into the ambient space using the air flow control system.

4. A system as recited in claim 3, wherein the microcontroller is programmable.

5. A system as recited in claim 4, wherein the microcontroller is programmable wirelessly.

6. A system as recited in claim 3, wherein the working fluid flow control valve actuator is located at the working fluid flow control value.

7. A system as recited in claim 3, wherein the air flow valve actuator is positioned at the air flow control valve.

8. A method for controlling air temperature in an ambient space in a vehicle using an environmental control system that comprises a temperature adjusted air source system and an ambient sensor system in thermal communication with the ambient space, the method comprising:
providing a digital microcontroller;
operatively coupling the digital microcontroller to the ambient sensor system;
operatively coupling a working fluid flow control valve actuator to a working fluid flow control value, the working fluid flow control valve being operative to control the flow of a working fluid in the temperature adjusted air source system, and operatively coupling the working fluid flow control valve actuator to the microcontroller;
using a control signal source to provide a control signal; and
using the microcontroller to issue commands to the working fluid flow control valve actuator in response to the control signal to control the flow of the working fluid in the temperature adjusted air source system.

9. A method for controlling air temperature in an ambient space in a vehicle using an environmental control system that comprises a temperature adjusted air source system, an air flow control system and an ambient sensor system in thermal communication with the ambient space, the method comprising:
providing a digital microcontroller;
operatively coupling the digital microcontroller to the ambient sensor system;
operatively coupling an air flow valve actuator to an air flow valve operative to control air flow from the temperature adjusted air source system that enters the ambient space, and operatively coupling the air flow valve actuator to the microcontroller;
using a control signal source to provide a control signal; and
using the microcontroller to issue commands to the air flow valve actuator in response to the control signal to control the flow of air into the ambient space using the air flow control system.

10. A method for controlling air temperature in an ambient space in a vehicle using an environmental control system that comprises a temperature adjusted air source system, an air flow control system and an ambient sensor system in thermal communication with the ambient space, the method comprising:
providing a digital microcontroller;
operatively coupling the digital microcontroller to the ambient sensor system;
operatively coupling a working fluid flow control valve actuator to a working fluid flow control value, the working fluid flow control valve being operative to control the flow of a working fluid in the temperature adjusted air source system, and operatively coupling the working fluid flow control valve actuator to the microcontroller;
operatively coupling an air flow valve actuator to an air flow valve operative to control air flow from the temperature adjusted air source system that enters the ambient space, and operatively coupling the air flow valve actuator to the microcontroller;
using a control signal source to provide a control signal; and
using the microcontroller to issue commands to the working fluid flow control valve actuator and the air flow valve actuator in response to the control signal to control the flow of the working fluid in the temperature adjusted air source system and to control the flow of air into the ambient space using the air flow control system, respectively.
